(19) United States
(12) Patent Application Publication
(10) Pub. No.: US 2026/0159791 A1
(43) Pub. Date: Jun. 11, 2026

(54) SUPERCRITICAL CARBON DIOXIDE EXTRACTION OF THE ESSENCE OF OAK BARRELS FOR WHISKEY MANUFACTURING

(71) Applicant: North Carolina State University, Raleigh, NC (US)

(72) Inventors: Marko Hakovirta, Cary, NC (US); Salonika Aggarwal, Raleigh, NC (US)

(73) Assignee: North Carolina State University, Raleigh, NC (US)

(21) Appl. No.: 19/180,688

(22) Filed: Apr. 16, 2025

Related U.S. Application Data
(60) Provisional application No. 63/634,501, filed on Apr. 16, 2024.

(51) Int. Cl. C12G 3/07; A23L 27/27

(52) U.S. Cl. CPC C12G 3/07; A23L 27/27

(57) ABSTRACT

Provided are methods of separating one or more components of interest from a matrix comprising lignocellulosic material or a derivative thereof. In some embodiments the method comprises contacting the matrix with supercritical carbon dioxide (CO₂), thereby providing (i) an extractant, wherein the extractant comprises the one or more components of interest, and (ii) an extracted matrix, further wherein: the matrix is oak wood and the one or more components of interest comprise one or more whiskey-related flavor and/or smell compounds; or the matrix is Kraft lignin and the one or more components of interest comprise one or more organic sulfur compounds. Products comprising the extractants are also disclosed.

### CROSS REFERENCE TO RELATED APPLICATIONS

This application claims priority to and benefit of U.S. Provisional Patent Application Ser. No. 63/634,501, filed Apr. 16, 2024, the disclosure of which is incorporated by reference herein in its entirety.

### TECHNICAL FIELD

The presently disclosed subject matter relates to methods of separating components of interest from lignocellulosic matrices or matrices derived therefrom. The methods can comprise contacting the matrices with supercritical carbon dioxide (CO₂) to extract one or more components of interest, such as one or more whiskey-related flavor and/or smell compounds or one or more sulfur compounds. In some embodiments, the presently disclosed subject matter further relates to the extracted compounds, the extracted matrix, and/or to uses thereof.

### BACKGROUND

There is consumer demand for whiskey-related products, including both whiskey itself, as well as other products that have a whiskey flavor or aroma. The traditional whiskey manufacturing process, however, is time consuming, typically involving significant periods of aging, during which a distilled alcoholic liquid prepared from the fermentation of a grain mash is stored in a wood barrel. During aging, for example, the alcoholic liquid penetrates into the barrel wood, extracts soluble wood-derived compounds (e.g., wood phenols and other volatile compounds), partially degrades the barrel to further release wood-derived compounds, reacts those compounds with compounds in the liquid, undergoes oxidation reactions, etc. The aging process can significantly modify the appearance, taste, smell, and other qualities of the whiskey, thereby providing enhanced qualities desired by consumers and rendering the whiskey more valuable.

One factor in the length of time needed to age whiskey is that only a small percentage of the wood in the barrels contacts the alcoholic liquid held therein. Other drawbacks related to wood barrel aging include: the cost of the barrels and their maintenance, storage requirements for the barrels during aging, loss of whiskey due to evaporation, the risk of leakage, and the risk of possible microorganism contamination. Thus, there is an ongoing need for the development of alternative methods to age whiskey, particularly those that provide the same taste, smell, and appearance provided by barrel aging.

In addition to the role of wood-derived compounds in whiskey aging, many other components derived from lignocellulosic materials have value. One of these other components is lignin. While lignin is currently used mainly as a source of energy or heating, lignin can potentially be used for several additional applications, including as a chemical feedstock for products such as, but not limited to, adhesives, coatings, plastic packaging materials, carbon fibers, composite materials, antioxidants, and sun screens. The global production of isolated lignin for ligno-sulphonate production is currently around 1.3 million tons. The majority of that isolated lignin is derived from the acid sulphite pulping process, with a smaller amount, about 104,000 tons, derived from the Kraft pulping process. However, this represents only a small amount of the estimated 70 million tons of lignin available from Kraft pulp production worldwide, where much of the lignin is not isolated, but is instead burned in a chemical recovery process onsite at pulp production facilities to provide steam for heat and power production. If additional lignin was isolated and sold as a renewable (or “green”) chemical feedstock, related lignin-based product development could enhance the product portfolio of aging pulp and paper mills and enhance the cost effectiveness of emerging biofuel/bioenergy technologies.

Currently, one hurdle for lignin use in many applications is the odor that comes from the sulfur associated with the Kraft pulping process, which results in sulfur compounds that remain in the lignin. Kraft lignin usually contains between about 2 to about 3% total sulfur. Sulfur deters many of the potential applications of sulfur due to the foul smell of sulfur compounds. Accordingly, there is an ongoing need for methods of removing sulfur compounds from Kraft lignin.

### SUMMARY

The presently disclosed subject matter provides a method of separating one or more components of interest from a matrix comprising a lignocellulosic material or a derivative thereof. In some embodiments, the method comprises contacting the matrix with supercritical CO₂, thereby providing (i) an extractant, wherein the extractant comprises one or more components of interest, and (ii) an extracted matrix. In some embodiments, the matrix is wood (e.g., oak wood) and the one or more components of interest comprise one or more whiskey-related flavor and/or smell compounds. In some embodiments, the matrix is lignin (e.g., Kraft lignin) and the one or more components of interest comprise one or more sulfur compounds. The presently disclosed subject matter also provides extractants (e.g., food or beverage flavorings) comprising whiskey-related compounds extracted from wood using supercritical CO₂ or desulfurized lignin prepared by removing sulfur compounds from lignin using supercritical CO₂.

Accordingly, it is an object of the presently disclosed subject matter to provide a method of separating one or more components of interest from a matrix comprising a lignocellulosic material or a derivative thereof. This and other objects are achieved in whole or in part by the presently disclosed subject matter.

An object of the presently disclosed subject matter having been stated above, other objects and advantages of the presently disclosed subject matter will become apparent to those of ordinary skill in the art after a study of the following description of the presently disclosed subject matter.

### DETAILED DESCRIPTION

The presently disclosed subject matter will now be described more fully hereinafter with reference to representative embodiments. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

### I. Definitions

Unless otherwise defined, all technical and scientific terms used herein have the same meaning as commonly understood by one of ordinary skill in the art to which this presently described subject matter belongs. All publications, patent applications, patents, and other references mentioned herein are incorporated by reference in their entirety.

While the following terms are believed to be well understood by one of ordinary skill in the art, the following definitions are set forth to facilitate explanation of the presently claimed subject matter.

Following long-standing patent law convention, the terms “a”, “an”, and “the” refer to “one or more” when used herein, including in the claims.

As used herein, the term “about”, when referring to a value or an amount, for example, of temperature, volume, pressure, time or another measure, is meant to encompass variations of in some embodiments ±20%, in some embodiments ±10%, in some embodiments ±5%, in some embodiments ±1%, and in some embodiments ±0.1% from the specified value or amount, as such variations are appropriate. The term “about” can be applied to all values set forth herein.

As used herein, the term “and/or” when used in the context of a listing of entities, refers to the entities being present singly or in combination. Thus, for example, the phrase “A, B, C, and/or D” includes A, B, C, and D individually, but also includes any and all combinations and sub-combinations of A, B, C, and D.

The term “comprising”, which is synonymous with “including,” “containing,” or “characterized by” is inclusive or open-ended and does not exclude additional, unrecited elements or method steps. “Comprising” is a term of art used in claim language which means that the named elements are present, but other elements can be added and still form a construct or method within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

The term “supercritical” as used herein refers to a substance at a pressure and temperature above its critical point where there are no distinct liquid and gas phases. The critical point for CO₂, for example, is 304.25 K at 7.39 MPa (or 31.1° C. at 1072 psi or 31.2° C. at 73.8 bar).

The term “lignocellulosic” refers to a composition comprising both lignin and cellulose. In some embodiments, lignocellulosic material can comprise hemicellulose, a polysaccharide which can comprise saccharide monomers other than glucose. Typically, lignocellulosic materials comprise between about 38-50% cellulose, 15-30% lignin, and 23-32% hemicellulose.

Lignocellulosic materials include a variety of plants and plant materials, such as, but not limited to, papermaking sludge; wood (both hard wood and softwood) and wood-related materials, e.g., saw dust, particle board, leaves, or trees, such as poplar trees; grasses, such as switchgrass and sudangrass; grass clippings; rice hulls; bagasse (e.g., sugar cane bagasse), jute; hemp; flax; bamboo; sisal; abaca; hays; straws; corn cobs; corn stover; whole plant corn, and coconut hair.

As used herein, the term “lignocellulosic matrix” refers to a plant-derived material comprising both lignin and cellulose (such as wood, wood chips, or ground wood) that has similar chemical composition to a plant or plant part found in nature. The term “derivative” used in reference to a lignocellulosic matrix refers to a matrix comprising material derived from a lignocellulosic matrix but having altered chemical composition. Thus, the term derivative can refer to wood pulp treated to remove lignin or to lignin removed from a lignocellulosic material, such as Kraft lignin.

“Lignin” is a polyphenolic material comprised of phenyl propane units linked by ether and carbon-carbon bonds. Lignins can be highly branched and can also be crosslinked. Lignins can have significant structural variation that depends, at least in part, on the plant source involved.

The term “cellulose” refers to a polysaccharide of β-glucose (i.e., β-1,4-glucan) comprising β-(1-4) glycosidic bonds. The term “cellulosic” refers to a composition comprising cellulose.

The term “hemicellulose” can refer polysaccharides comprising mainly sugars or combinations of sugars other than glucose (e.g., xylose). Thus, xylan (polymerized xylose) and mannan (polymerized mannose) are exemplary hemicelluloses. Hemicellulose can be highly branched. Hemicellulose can be chemically bonded to lignin and can further be randomly acetylated, which can reduce enzymatic hydrolysis of the glycosidic bonds in hemicellulose.

The terms “glycosidic bond” and “glycosidic linkage” refer to a linkage between the hemiacetal group of one saccharide unit and the hydroxyl group of another saccharide unit.

The Kraft (or sulfate) process used in paper plants during pulping (i.e., the conversion of wood into wood pulp) refers to a process of treating wood chips with a mixture of sodium hydroxide and sodium sulfide (i.e., “white liquor”) to remove lignin. During the process, sulfide (S²⁻) and/or hydrosulfide (HS⁻) ions cleave ether linkages present in lignin. The wood chips and white liquor are typically reacted for several hours at temperatures between about 130-180° C. The hemicellulose and lignin present in the wood chips degrade into fragments that are soluble in strong alkaline solutions. The remaining solid pulp is collected and washed, while the liquids (known as “black liquor”), which contain lignin, degraded hemicellulose and cellulose fragments, sodium carbonate, sodium sulfate and other inorganic salts are also collected. Thus, the term “Kraft lignin” refers to a composition comprising lignin from black liquor resulting as a by-product of the Kraft pulping process.

### II. Extraction of Whiskey Essence

In one aspect, the presently disclosed subject matter relates to a method of extracting whiskey-related flavor and/or aroma compounds from wood. More particularly, in some embodiments, the presently disclosed subject matter is based on a method of using supercritical CO₂ extraction of oak whiskey barrels to provide an extractant comprising one or more compounds associated with whiskey flavor and/or smell.

In some embodiments, the presently disclosed subject matter provides a method of separating one or more components of interest from a matrix comprising lignocellulosic material or a derivative thereof. In some embodiments, the method comprises contacting the matrix with supercritical CO₂, thereby providing (i) an extractant, wherein the extractant comprises the one or more components of interest, and (ii) an extracted matrix, further wherein the matrix is oak wood (i.e., wood from a tree or bush of the family Quercus) and the one or more components of interest comprise one or more whiskey-related flavor and/or smell compounds. Different woods and/or different treatment of the wood prior to extraction can provide a different flavor and/or aroma profile to the extractant, e.g., by providing extractants comprising different mixtures of wood-derived molecules. In some embodiments, the oak wood is wood from a barrel previously used to age whiskey or another alcoholic beverage (e.g., brandy, rum, or sherry). In some embodiments, the oak wood is American oak (e.g., Quercus borealis). In some embodiments, the oak wood is French oak (e.g., Quercus robur or Quercus petraea). In some embodiments, the oak wood is red oak wood. In some embodiments, the red oak wood is cherrybark oak wood (i.e., Quercus pagoda). In some embodiments, the oak wood is charred or smoked. In some embodiments, combinations of different woods (e.g., including some charred or smoked wood and some non-charred or smoked wood or including two or more different types of oak) can be used.

In some embodiments, the wood can be reduced in size prior to the extraction, e.g., using a mechanical size reduction process. In some embodiments, the oak wood can be ground or chipped prior to the contacting.

In some embodiments, the wood can be placed in a pressure vessel into which supercritical CO₂ can be introduced so that it can contact the wood. The pressure vessel can include components to control the temperature and pressure inside the vessel. After contacting the wood, the supercritical CO₂ can then be passed into a vessel at a lower pressure than the pressure vessel, so that extracted wood compounds present in the supercritical CO₂ can be separated from the CO₂ and collected. Apparatus for performing supercritical fluid (SCF) extraction are known in the art. Suitable apparatus for performing the presently disclosed method can include, for example, a pressure vessel, a carbon dioxide tank or other carbon dioxide source, one or more pumps, one or more pressure regulators, and a collection vessel. An exemplary apparatus for performing the presently disclosed method is an OCO Laboratories Super C unit (OCO Labs, Inc., Sierra Vista, Arizona, United States of America).

In some embodiments, the contacting is performed at a pressure between about 2500 pounds per square inch (psi) and about 5000 psi (e.g., about 2500, 3000, 3500, 4000, 4500, or about 5000 psi). In some embodiments, the contacting is performed at a pressure between about 3000 psi and about 3500 psi (e.g., about 3000, 3100, 3200, 3300, 3400, or about 3500 psi). In some embodiments, the contacting is performed at a temperature of between about 50 degrees Celsius (° C.) and about 80° C. (e.g., about 50, 55, 60, 65, 70, 75, or about 80° C.). In some embodiments, the contacting is performed at a temperature between about 60° C. and about 70° C. (e.g., about 60, 61, 62, 63, 64, 65, 66, 67, 68, 69, or about 70° C.). In some embodiments, a representative, non-limiting supercritical CO₂ /matrix mass ratio ranges from about 5 to about 25 on a dry basis. Other suitable amounts of supercritical CO₂ including supercritical CO₂ /matrix mass ratios would be apparent to one of ordinary skill in the art up on a review of the instant disclosure.

In some embodiments, the contacting is performed continuously for a single period of time. For example, a single portion of supercritical CO₂ can be contacted with the wood in the pressure vessel for a single period of time, and then the supercritical CO₂ (now containing one or more extracted compounds from the wood) can be passed out of the pressure vessel and the extractant separated from the CO₂ and collected. In some embodiments, the single period of time is about 1 hour or less (e.g., between about 15 minutes and about 60 minutes). In some embodiments, the single period of time is about 45 minutes. In some embodiments, the single period of time is about 30 minutes.

Alternatively, the presently disclosed methods can employ a cyclical extraction process involving multiple short (e.g., less than 15 or 10 minutes) extraction periods. For example, a first portion of supercritical CO₂ can be contacted with the wood in the pressure vessel for a short period of time and then passed out of the pressure vessel to separate and collect the extractant. Then a second portion of supercritical CO₂ can be introduced into the pressure vessel to contact the wood for a similar short period of time. After the second portion of CO₂ is passed out of the pressure vessel and the extractant separated and added to the extractant collected from the first portion of supercritical CO₂, the extraction process can optionally be repeated for one or more additional extraction periods. In some embodiments, the contacting is performed over a series of two or more noncontinuous time periods, optionally wherein each of the two of more noncontinuous time periods is about 1 to about 10 minutes (e.g., about 1, 2, 3, 4, 5, 6, 7, 8, 9, or 10 minutes). In some embodiments, each noncontinuous time period is about 5 minutes. In some embodiments, the two or more noncontinuous time periods comprise two, three, four, five, or six noncontinuous time periods (i.e., the method can comprise 2, 3, 4, 5, or 6 extraction cycles). Employing a cyclic extraction process can be useful in eliminating saturation of the supercritical CO₂. In some embodiments, the total extraction time can be reduced and/or more effective when a series of noncontinuous extraction periods are used as compared to when a single extraction period is used.

In some embodiments, the one or more whiskey-related flavor and/or smell compounds comprise one or more compounds selected from the group comprising lactones, aldehydes, esters, and phenolics. Each of the one or more whiskey-related flavor and/or smell compound can be a compound such as, but not limited to, cis-3-methyl-4-octanolide, trans-3-methyl-4-octanolide, vanillin, furfural, hexanal, acetaldehyde, 2-methylbutanal, 3-methylbutanal, syringaldehyde, ethyl hexanoate, isoamyl acetate, guaiacol, eugenol, ortho-cresol, meta-cresol, and para-cresol.

In some embodiments, the method further comprises using the extractant as a food or beverage flavoring. For example, the extractant (which can also be referred to as an “essence”) can be used to enhance the flavor and/or aroma of whiskey, e.g., thereby providing a whiskey that tastes and/or smells like it was aged in oak barrels or aged in oak barrels for a longer period of time. In some embodiments, the extractant can be used as a flavoring for other beverages (e.g., tea, coffee, vodka, beer, etc.) or used as a flavoring for food, e.g., in baked goods, chocolate, candy, cheese, or in sauces for meats, fish, or other foods. Thus, in some embodiments, the extractant can be formulated as an extract for use in cooking. The extractant can also be used as a component of a cologne or perfume or to provide a whiskey aroma or fragrance to a product, such as a candle, an air freshener, a cleaning product, a soap, or another personal care product (e.g., a shaving cream or a shampoo).

In some embodiments, the presently disclosed subject matter provides a product (e.g., a food or beverage or a cologne) comprising an extractant provided by the presently disclosed subject matter.

### III. Extraction of Sulfur Compounds

Lignin is an organic bio-based polymer that can be found in woody biomass. Lignin is involved, for instance, in the formation of the strength and mechanical properties of cell walls in wood and bark. Lignin is a complex polymer whose composition can vary by plant species, but is generally composed of about 60% carbon, about 6% hydrogen, about 1% ash (i.e., mineral components), and about 30% oxygen.

In the pulp and paper industry, there has been a continuous drive to extract lignin from black liquor, a by-product of the Kraft pulping process. Lignin value has been traditionally considered as energy related only. However, more recently, the high potential for lignin use in various applications has created interest in the development of new “green products” from renewable sources, e.g., replacements for conventional plastic bags and other packaging, carbon fibers, composites, antioxidants and sun screens. Lignin can also be used to prepare adhesives and lubricants.

One drawback for such lignin applications, however, is the odor that comes from the sulfur associated with the Kraft process. Kraft lignin typically contains 2-3% total sulfur, which is present as foul-smelling sulfur-containing compounds. Sulfur-free lignin is thus considered more valuable.

In some embodiments, the presently disclosed subject matter provides a method of desulfurizing Kraft lignin to reduce or eliminate sulfur-related odor. More particularly, the method comprises extracting Kraft lignin with supercritical CO₂. This extraction provides an extracted, reduced odor lignin and an extractant that is an oil-like liquid with a highly concentrated sulfur smell. The extraction can also reduce the moisture content of the lignin. In some embodiments, the moisture content of the lignin is reduced by about 60%.

Accordingly, in some embodiments, the presently disclosed subject matter provides a method of separating one or more components of interest from a matrix comprising lignocellulosic material or a derivative thereof. In some embodiments, the method comprises contacting the matrix with supercritical carbon dioxide (CO₂), thereby providing (i) an extractant, wherein the extractant comprises the one or more components of interest, and (ii) an extracted matrix, further wherein the matrix is Kraft lignin and the one or more components of interest comprise one or more organic sulfur compounds.

In some embodiments, the Kraft lignin can be placed in a pressure vessel into which supercritical CO₂ can be introduced so that it can contact the lignin. The pressure vessel can include components to control the temperature and pressure inside the vessel. After contacting the lignin, the supercritical CO₂ can then be passed into a vessel at a lower pressure than the pressure vessel, so that compounds extracted from the lignin can be separated from the CO₂ and collected. An exemplary apparatus for performing the presently disclosed method is an OCO Laboratories Super C unit (OCO Labs, Inc., Sierra Vista, Arizona, United States of America).

In some embodiments, the contacting is performed at a pressure of between about 2500 psi and about 3500 psi (e.g., about 2500, 2600, 2700, 2800, 2900, 3000, 3100, 3200, 3300, 3400, or about 3500 psi). In some embodiments, the contacting is performed at a pressure of about 3500 psi. In some embodiments, the contacting is performed at a temperature of between about 60° C. and about 80° C. (e.g., about 60, 62, 64, 66, 68, 70, 72, 74, 76, 78, or about 80° C.). In some embodiments, the contacting is performed at about 60° C. In some embodiments, a representative, non-limiting supercritical CO₂/matrix mass ratio ranges from about 5 to about 25 on a dry basis. Other suitable amounts of supercritical CO₂ including supercritical CO₂/matrix mass ratios would be apparent to one of ordinary skill in the art up on a review of the instant disclosure.

In some embodiments, the contacting is performed continuously for a single period of time. For example, a single portion of supercritical CO₂ can be contacted with the lignin in the pressure vessel for a single period of time, and then the supercritical CO₂ (now containing one or more extracted sulfur compounds from the lignin) can be passed out of the pressure vessel and the extractant separated from the CO₂ and collected. In some embodiments, the single period of time is about 1 hour or less (e.g., between about 15 minutes and about 60 minutes).

Alternatively, the presently disclosed methods can employ cyclical extraction processes involving multiple short (e.g., less than 15 or 10 minutes) extraction periods. For example, a first portion of supercritical CO₂ can be contacted with the lignin in the pressure vessel for a short period of time and then passed out of the pressure vessel to separate and collect the extractant. Then a second portion of supercritical CO₂ can be introduced into the pressure vessel to contact the lignin for a similar short period of time. After the second portion is passed out of the pressure vessel and the corresponding extractant separated from the CO₂ and added to the extractant collected from the first portion of supercritical CO₂, the process can optionally be repeated for one or more additional extraction periods. In some embodiments, the contacting is performed over a series of two or more noncontinuous time periods, optionally wherein each of the two of more noncontinuous time periods is about 1 to about 10 minutes (e.g., about 1, 2, 3, 4, 5, 6, 7, 8, 9, or 10 minutes). In some embodiments, each noncontinuous time period is about 5 minutes. In some embodiments, the two or more noncontinuous time periods comprise two, three, four, five, or six noncontinuous time periods (i.e., the extraction can comprise 2, 3, 4, 5, or 6 extraction cycles). Employing a cyclic extraction process can be useful in eliminating saturation of the supercritical CO₂. In some embodiments, the total extraction time can be reduced and/or more effective when a series of noncontinuous extraction periods are used as compared to when a single extraction period is used.

In some embodiments, the extracted matrix (i.e., the remaining matrix after the extraction) comprises desulfurized lignin wherein the desulfurized lignin contains less than 0.5%, less than 0.4%, less than 0.3%, less than 0.2%, or less than 0.1% total sulfur. In some embodiments, the desulfurized lignin comprises reduced sulfur-related odor as compared to the initial Kraft lignin before the extraction process. In some embodiments, the desulfurized lignin has no detectable sulfur. In some embodiments, the desulfurized lignin is free of sulfur smell.

In some embodiments, the method further comprises using the extracted lignin (i.e., the desulfurized lignin) as a chemical feed material. In some embodiments, the extracted lignin is used as a chemical feedstock in the production of one or more compositions including, but not limited to, an adhesive, a coating, a plastic bag or other packaging material, carbon fibers, composite materials, an antioxidant, and a sun screen.

In some embodiments, the presently disclosed subject matter provides a desulfurized lignin prepared by extracting Kraft lignin with supercritical CO₂. In some embodiments, the presently disclosed subject matter provides a product prepared from desulfurized lignin prepared by extracting Kraft lignin with supercritical CO₂. In some embodiments, the product is selected from an adhesive, a coating, a plastic bag or other packaging material, carbon fibers, composite materials, an antioxidant, and a sun screen.

The following reference is incorporated herein by reference in its entirety to the extent that it supplements, explains, provides a background for, or teaches methodology, techniques, and/or compositions employed herein: Aggarwal et al., Ind. Eng. Chem. Res. 2019, 58, 8, 3170-3174.

It will be understood that various details of the presently disclosed subject matter can be changed without departing from the scope of the presently disclosed subject matter. Furthermore, the foregoing description is for the purpose of illustration only, and not for the purpose of limitation.

What is claimed is:

1. A method of separating one or more components of interest from a matrix comprising lignocellulosic material or a derivative thereof, wherein the method comprises contacting the matrix with supercritical carbon dioxide (CO₂), thereby providing (i) an extractant, wherein the extractant comprises the one or more components of interest, and (ii) an extracted matrix, further wherein:
(a) the matrix is oak wood and the one or more components of interest comprise one or more whiskey-related flavor and/or smell compounds; or
(b) the matrix is Kraft lignin and the one or more components of interest comprise one or more organic sulfur compounds.

2. The method of claim 1, wherein the matrix is oak wood and the one or more components of interest comprise one or more whiskey-related flavor and/or smell compounds.

3. The method of claim 2, wherein the oak wood is wood from a barrel previously used to age whiskey or another alcoholic beverage.

4. The method of claim 2, wherein oak wood is a red oak wood, optionally a cherrybark oak wood.

5. The method of claim 2, wherein the oak wood is charred or smoked.

6. The method of claim 2, wherein the oak wood is ground prior to the contacting.

7. The method of claim 2, wherein the contacting is performed at a pressure between about 2500 pounds per square inch (psi) and about 5000 psi, optionally between about 3000 psi and about 3500 psi.

8. The method of claim 2, wherein the contacting is performed at a temperature of between about 50 degrees Celsius (° C.) and about 80° C., optionally between about 60° C. and about 70° C.

9. The method of claim 2, wherein the contacting is performed continuously for a single period of time.

10. The method of claim 9, wherein the single period of time is about 1 hour or less, optionally wherein the single period of time is about 45 minutes or about 30 minutes.

11. The method of claim 2, wherein the contacting is performed over a series of two or more noncontinuous time periods, optionally wherein each of the two of more noncontinuous time periods is about 5 minutes.

12. The method of claim 2, wherein the one or more whiskey-related flavor and/or smell compounds comprise one or more compounds selected from the group consisting of lactones, aldehydes, esters, and phenolics.

13. The method of claim 12, wherein the one or more whiskey-related flavor and/or smell compounds comprise one or more compounds selected from the group consisting of cis-3-methyl-4-octanolide, trans-3-methyl-4-octanolide, vanillin, furfural, hexanal, acetaldehyde, 2-methylbutanal, 3-methylbutanal, syringaldehyde, ethyl hexanoate, isoamyl acetate, guaiacol, eugenol, ortho-cresol, meta-cresol, and para-cresol.

14. The method of claim 2, further comprising using the extractant as a food or beverage flavoring.

15. The method of claim 1, wherein the matrix is Kraft lignin and the one or more components of interest comprise one or more organic sulfur compounds.

16. The method of claim 15, wherein contacting is performed at a pressure of between about 2500 psi and about 3500 psi, optionally wherein the contacting is performed at a pressure of about 3500 psi.

17. The method of claim 15, wherein the contacting is performed at a temperature of between about 60° C. and about 80° C., optionally wherein the contacting is performed at about 60° C.

18. The method of claim 15, wherein the contacting is performed continuously for a single period of time.

19. The method of claim 18, wherein the single period of time is about 1 hour or less.

20. The method of claim 15, wherein the contacting is performed over a series of two or more noncontinuous time periods, optionally wherein each of the two of more noncontinuous time periods is about 5 minutes.

21. The method of claim 15, wherein the extracted matrix comprises desulfurized lignin.

22. The method of claim 21, wherein the desulfurized lignin is free of sulfur smell.

23. The method of claim 21, further comprising using the extracted matrix as a chemical feed material, optionally wherein the chemical feed material is for production of one or more of the group comprising an adhesive, a coating, a plastic bag or other packaging material, carbon fibers, composite materials, an antioxidant, and a sun screen.

24. A food or beverage flavoring prepared according to the method of claim 14.

25. A food or beverage comprising the food or beverage flavoring of claim 24.

26. A desulfurized lignin prepared according to the method of claim 21.

27. A product prepared from the desulfurized lignin of claim 26, optionally wherein the product is selected from the group comprising an adhesive, a coating, a plastic bag or other packaging material, carbon fibers, composite materials, an antioxidant, and a sun screen.
